(19) United States
(12) Patent Application Publication
(10) Pub. No.: US 2011/0007503 A1
(43) Pub. Date: Jan. 13, 2011

(54) Versatile valance light fixture

(76) Inventors: Daniel Caron, Saint-Jerome (CA); Guy Drapeau, Saint-Jerome (CA)

Correspondence Address: Invention Quebec Inc., 8065, boul. Viau Bureau 202, Montreal, QC, H1R 2T2, CA

(21) Appl. No.: 12/801,992

(22) Filed: Jul. 7, 2010

(30) Foreign Application Priority Data
Jul. 7, 2009 (GB) 0911830.8

(51) Int. Cl. F21S 4/00; F21S 13/02

(52) U.S. Cl. 362/225; 362/432

(57) ABSTRACT

A versatile valance light fixture having a light emitting member that can be easily removed for maintenance or replacement, as well as being relatively easily customizable in terms of the direction and the color of the light that it is emitting toward its surrounding space. Furthermore, a plurality of versatile valance light fixtures can be easily connected in a daisy chain configuration.

This application claims priority from GB No. 0911830.8

### FIELD OF THE INVENTION

The present invention relates generally to valance light fixtures and, more particularly, to a versatile valance light fixture that is relatively easily customizable to specific decorative needs.

### BACKGROUND OF THE INVENTION

Valance light fixtures are known in the art and are used to add accent or ambiance lighting behind a curtain headrail, around the periphery of ceilings, on top surface portions of kitchen cabinets, and the likes.

Valance light fixtures of the prior art generally take the form of elongated neon light fixtures or elongated light strip fixtures comprising solid state, light emitting diodes, or LED's.

The typically elongated housing of the valance light fixtures is generally directly fixed to a support structure, such as a wall portion, a windowsill, or the like, using conventional fastening means such as screws, nails, construction grade staples, or the like. Thus, once a valance light fixture is fastened to a support structure, it is generally not easily removed for maintenance reasons such as, for examples, a thorough cleaning, a repair or a replacement procedure, without using hand tools.

The valance light fixtures of the prior art generally emit light in a fixed direction that is not easily customizable. For examples, they generally either emit light along one, two or three longitudinal sides. Thus, to satisfy varied decorative needs of end clients, the factories or home hardware stores have to keep a large inventory of valance light fixtures that are emitting light in various directions.

Furthermore, valance light fixtures of the prior art made of LED light strips that generally emit light in a single fixed color that is not easily customizable, unless the valance light is equipped with more expensive light strips comprising LED's of various colors that are controlled by custom electronic control circuits.

Against this background, there exist a need for a new and improved valance light fixture that avoids the aforementioned disadvantages.

### SUMMARY OF THE INVENTION

It is a general object of the present invention to provide a new and improved valance light fixture. According to a preferred embodiment of the present invention, the valance light fixture generally includes an electrically powered elongated light emitting member, and a pair of differently shaped and configured mounting brackets, for mounting the light emitting member to a surface portion of a support structure.

The elongated light emitting member is generally represented by an assembly comprising an elongated tubular housing closed at each distal ends with suitably adapted end caps. At least one of the end caps is suitably adapted with an aperture for receiving therethrough a power cable for powering the fixture.

The elongated tubular housing may as well be closed at both ends with identical end caps having an aperture, as described above, for allowing a plurality of light emitting members to be serially interconnected with interstitial power cables, in a daisy chain configuration.

The elongated tubular housing has a substantially square-shaped cross-section, thus having four elongated longitudinal surfaces facing outwardly thereof. Three of the longitudinal surface are made of a transparent, or at least translucent plastic material, while the fourth longitudinal surface is provided with a longitudinally extending groove adapted to be engaged, in a snap-fit relation, with a mounting portion of the mounting brackets described above.

Thus, the light emitting member, in cooperative relation with the mounting brackets described above, may be mounted such that its distal transparent surface is directed perpendicularly outwardly, relative to the mounting surface of the support structure, or in a parallel direction relative to the latter.

The elongated tubular housing comprises an inner, elongated channel member that is extending substantially the length of the housing, and which serves as a support structure for at least one, and possibly up to three elongated LED light strips therein. Thus, between one and three elongated LED light strips may be disposed longitudinally along selected transparent longitudinal surfaces of the tubular housing.

Furthermore, the elongated channel member serves also as a strengthening structural element for the light emitting member.

The tubular housing member, the end caps and the mounting support brackets are preferably made of a suitably rigid plastic material using conventional extruding or injection molding processes. The elongated channel member may be preferably made of a suitably rigid material whose rigidity is not significantly affected by the accumulated heat that may be generated by high intensity LED light strips within the tubular housing member. For example, the channel member may be made of aluminum, a suitable metal alloy, a suitable polymer, glass, or a composite material, that is preferably light weight and rust proof.

Thus there is provided a versatile valance light fixture having a light emitting member that can be easily removed for maintenance or replacement, as well as being relatively easily customizable in terms of the direction and the color of the light that it is emitting toward its surrounding space.

Other advantages and novel features of the present invention will be more apparent from the following drawings and detailed description.

### BRIEF DESCRIPTION OF THE DRAWINGS

FIG. 1 is a perspective view of a versatile valance light fixture, according to the present invention;

FIG. 2A is a perspective view of an elongated housing member;

FIG. 2B is a distal end plan view of the elongated housing member of FIG. 2A;

FIG. 3 is a distal end plan view of the versatile valance light fixture of FIG. 1, here shown having an end cap removed;

FIG. 4 is a distal end plan view of an elongated support channel having a substantially U-shaped cross-section;

FIG. 5 is a distal end plan view of the elongated support channel of FIG. 4, here shown with three elongated light strips inserted longitudinally in a corresponding number of suitably shaped, elongated side grooves provided along the three outer longitudinal sides of the elongated support channel of FIG. 4;

FIG. 6 is a front plan view of a conventional LED light strip;

FIG. 7 is a perspective view of the elongated support channel of FIG. 4, here shown having a portion of a LED light strip slidably inserted in one of the elongated side grooves of the elongated support channel of FIG. 4;

FIG. 8 is a perspective inner view of a first end cap provided with an inner aperture for receiving the wire ends of an external power source;

FIG. 9 is a perspective inner view of a second, closing end cap;

FIG. 10 is an inner plan view of the first end cap shown in FIG. 8;

FIG. 11 is a side plan view of the second end cap shown in FIG. 9;

FIG. 12 is a side plan view of the first end cap in FIG. 8, here shown with a portion of a power cable having a suitably configured and shaped distal end inserted in the aperture provided therethrough;

FIG. 13 is an inner plan view of the closing end cap of FIG. 9;

FIG. 14 is a perspective view of a 90 degree mounting bracket;

FIG. 15 is a side plan view of the 90 degree mounting bracket of FIG. 14;

FIG. 16 is a front plan view of the 90 degree mounting bracket of FIG. 14;

FIG. 17 is perspective view of a 180 degree mounting bracket;

FIG. 18 is a side plan view of the 180 degree mounting bracket of FIG. 17.

### DETAILED DESCRIPTION OF THE INVENTION

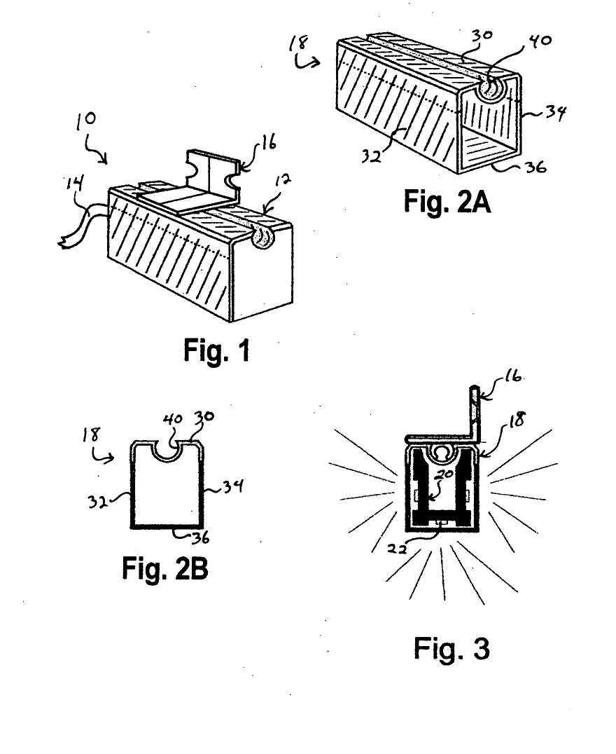

FIG. 1A shows various aspects of a preferred embodiment of a versatile valance light fixture 10 according to the present invention.

The versatile valance light fixture 10 generally includes an elongated light emitting member 12, a power cable 14, for powering the light emitting member 12, and at least one mounting bracket 16, adapted for mounting the light emitting member 12 to a support structure such as, for examples, a wall surface, a windowsill, a top surface portion of a kitchen cabinet, or the likes (not shown).

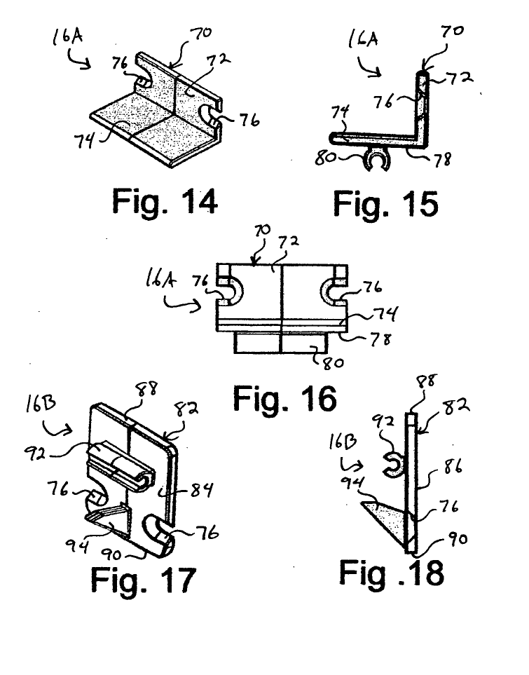

As it will be described in details further below, the versatile valance light fixture 10 may be mounted to a support structure using at least one, but preferably a plurality of mounting brackets 16. Furthermore, as best illustrated in FIGS. 14 to 18 inclusively, the versatile valance light fixture 10 may be mounted to a support structure using at least one of two differently configured mounting brackets, namely mounting brackets 16A and 16B.

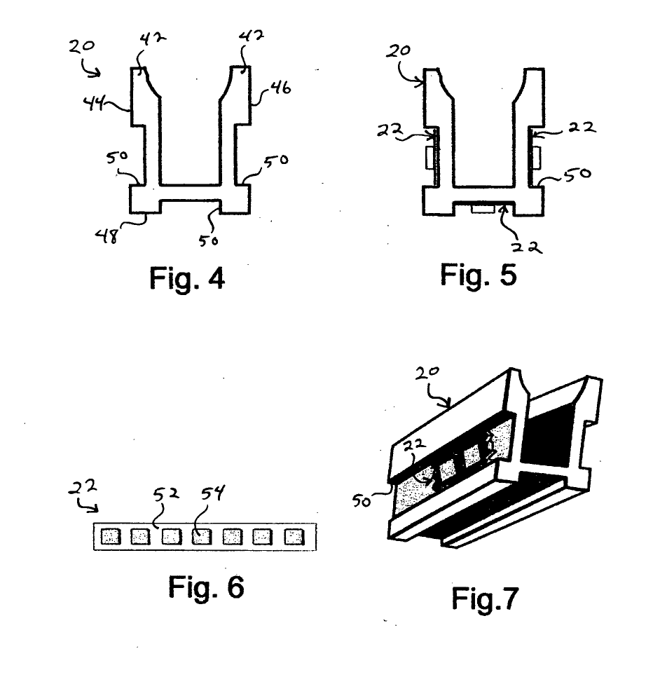

The light emitting member 12 is represented by an assembly that generally includes an elongated housing member 18, as best illustrated in FIGS. 2A and 2B, an elongated support channel 20 having a substantially U-shaped cross-section, as best illustrated in FIGS. 4 and 7, and at least one, and up to three elongated LED light strips 22, such as illustrated in FIG. 6.

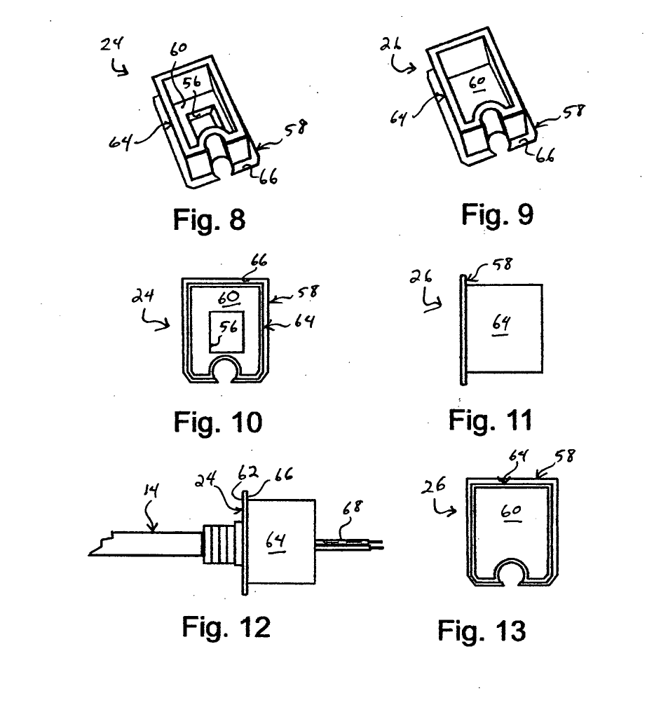

The light emitting member 12 further includes a first end cap 24 provided with an inner aperture 26, as illustrated in FIGS. 8 and 10, and a second, closing end cap 28, as illustrated in FIGS. 9 and 13. As it will be described in details more below, in some embodiments, the light emitting member 12 may include two end caps 24 having an inner aperture 26 instead of one end cap 24 and one end cap 28 as described above.

The light emitting member 12 still further includes a power cable 14 having a first distal end adapted to be inserted through the inner aperture 26 of an end cap 24, as illustrated in FIG. 12, and its opposite distal end being provided with a suitable power supply unit (not shown) conventionally used for indoor lighting fixtures.

FIGS. 2A and 2B show a tubular and substantially elongated housing member 18 having a substantially square shaped cross-section. The square shaped cross-section of the housing member 18 defines a longitudinal mounting surface 30, a pair of oppositely disposed, longitudinal side surfaces 32 and 34, and a distal longitudinal surface 36.

Substantially centered along the longitudinal mounting surface 30 there is provided a longitudinal mounting groove 40 extending inwardly relative to the surface 30, and defining a groove therein having a substantially near-circular cross-section. The longitudinal mounting groove 40 is adapted for resiliently engaging with a suitably shaped and configured mounting member of the mounting brackets 16A and 16B.

Housing member 18 is preferably represented by a single piece element made of a suitably rigid plastic material using a conventional extruding or injection molding process. As best illustrated in FIGS. 2B and 3, the mounting surface 30, including the longitudinal mounting groove 40 and relatively small, adjacent portions of the longitudinal side surfaces 32, 34, are preferably made of an opaque material, while the rest of the longitudinal side surfaces 32, 34 and the distal longitudinal surface 36 are made of a transparent, or at least a translucent material for allowing light to emit outwardly therefrom.

FIGS. 4, 5 and 7 show various aspects of an elongated channel member 20 having a substantially U-shaped cross-section.

The overall cross-sectional dimensions of the U-shaped channel member 20 are suitably sized and shaped such that the channel member 20 may be freely longitudinally inserted through an open end of the tubular housing member 18, with its distal longitudinal ends 42 being in register with the longitudinal spaces along either sides of the protruding inner surface defining the mounting groove 40, as illustrated in FIG. 3.

The three longitudinal outer surfaces 44, 46 and 48 of the U-shaped channel member 20 are provided with longitudinal inner grooves 50 having a substantially rectangular cross-section. The longitudinal inner grooves 50 are each suitably sized and shaped for freely slidably receiving therein the rear portion of an elongated LED light strip 22, as illustrated in FIGS. 3, 5 and 7.

The elongated U-shaped channel 20 is preferably made of a suitably rigid material whose rigidity is not significantly affected by the accumulated heat that may be generated by high intensity LED light strips 22 inserted in a fully assembled and powered versatile valance light fixture 10. For example, the U-shaped channel member 20 may be made of aluminum, a suitable metal alloy, a suitable polymer, glass, or a composite material, that is preferably light weight and rust proof.

Thus, the U-shaped channel member 20, which serves as a positioning element of the LED light strips 22 within the housing member 18, also serves as a strengthening structure element of an assembled valance light fixture 10.

An elongated LED light strip 22, as illustrated in FIG. 6, may be any conventional and commercially available LED light strip element having a suitable shape and size for allowing the light strip to be freely slidably engaged along the elongated inner grooves 50 of the U-shaped channel member 20.

A typical LED light strip 22 of the prior art, as illustrated in a front plan view in FIG. 6, and shown in a perspective partial view in FIG. 7, is generally represented by a substantially elongated printed circuit board 52 having soldered on a front side a plurality of light emitting diodes 54, or LED's, that are equidistantly disposed therealong.

FIGS. 8 to 13 inclusively show various aspects of a first end cap 24 provided with an aperture 56, and a second, closing end cap 26.

First end cap 24 may be represented by a single piece element having a plate portion 58 defining an inner side 60 and an outer side 62, and whose outer shape and dimensions are substantially identical to the cross-sectional outer shape and dimensions of the elongated housing member 18, including the semi-circular groove portion of the latter. A relatively short tubular portion 64, having a substantially identical but relatively smaller cross-section as the plate member 58, here again, including the semi-circular groove portion, has a first end integrally formed substantially centrally on the inner surface 60 of the plate member 58, and the opposite end extending perpendicularly therefrom. Thus, a relatively small abutting ledge 66 is formed about the periphery of the plate member 58.

Furthermore, the short tubular form 64 has an outer cross-sectional shape and dimensions allowing the latter to be slidably inserted, in a snug fit relation, within an open end of the elongated housing member 18 until the protruding periphery, or abutting ledge 66 of the plate member 58 firmly abuts against the distal end thereof, thus forming an end cap to the housing member 18.

As best mentioned above, and illustrated in FIGS. 8, 10 and 12, the end cap 24 is provided with an inner aperture 56 for receiving therethrough a distal end of a power cable 14 whose end wires 68 may be typically soldered to electrical contact points (not shown) provided at a distal end of a LED light strip 22 positioned inside the light emitting member 12.

Furthermore, a portion of the outer shielding, proximal the distal end of the power cable 14, is preferably suitably shaped and sized such that it may be resiliently engaged about the inner periphery of aperture 56 of the end cap 24, for providing a sufficient mechanical retention between the power cable 14 and the assembled light emitting member 22.

The second, closing end cap 26 is substantially identical to the first end cap described above, except that it is not provided with an aperture. Closing end cap 26 is mainly for the purpose of sealingly enclosing the distal end of an assembled U-shaped channel member 20 and LED light strips 22 combination within the elongated housing member 18.

The end caps 24 and 26 are preferably represented by single piece elements made of a suitably rigid plastic material using a conventional injection molding process.

The overall length of the U-shaped channel member 20 and the LED light strip or strips 22 may be preferably substantially equal. An assembled U-shaped channel member 20 and LED light strip 22 combination has a suitable overall length that is relatively shorter than the length of an elongated housing member 18, for allowing the channel member 20 and light strip 22 combination to be enclosed within the housing member 18, between the end caps.

Thus, an assembled elongated light emitting member 12 may include a U-shaped channel member 20, provided with at least one, and up to three LED light strips 22, that is inserted in a housing member 18, with a power cable 14 and end cap 24 combination for closing a first distal end, and an end cap 26 for closing the opposite distal end thereof.

In an alternate preferred embodiment, the closing end cap 26 may be replaced with an additional power cable 14 and end cap 24 combination, for allowing the connection in series of a plurality of light emitting members 12 in a daisy chain configuration.

FIGS. 14 to 18 inclusively, show various aspects of two differently shaped and configured mounting brackets, namely a first mounting bracket 16A and a second mounting bracket 16B.

FIGS. 14, 15 and 16 inclusively, show the first mounting bracket 16A that is generally represented by a relatively short right angle member 70 defining a first mounting portion 72 and a second mounting portion 74.

The first mounting portion 72 is provided with suitable mounting means such as, for example, a plurality of mounting holes or lateral recesses 76, for rigidly fixing the mounting bracket 16A against a mounting surface portion of a support structure using preferably flat-head screws, nails, or the like.

The second mounting portion 74 is provided, along its outer surface 78 thereof, with a mounting member 80 suitably shaped and sized for resiliently engaging within the longitudinal mounting groove 40 of the elongated housing member 18. The mounting member 80 is generally represented by a substantially cylindrically-shaped member having a C-shaped cross-section, and a longitudinal side portion, opposite the open side portion, that is integrally formed centrally longitudinally along the outer surface of the second mounting portion 74, as best illustrated in FIGS. 15 and 16.

The C-shaped cross-section of the mounting member 80 is suitably sized such that it exerts a sufficiently spring biased outward action against the inner cylindrical surface of the mounting groove 40 for resiliently retaining the mounting bracket therein.

Thus, the first mounting bracket 16A may be used for rigidly fixing a light emitting member 12, as described above, to a mounting surface portion of a support structure such that the distal longitudinal surface 36 of the light emitting member 12 may be projecting light in a substantially parallel direction relative to the mounting surface portion.

FIGS. 17 and 18 show a second mounting bracket 16B that is generally represented by a mounting plate member 82 defining a front side surface 84, a rear side surface 86, an upper edge 88, and a lower edge 90. The second mounting bracket 16B is provided with suitable mounting means such as, likewise the first mounting bracket 16A described above, a plurality of mounting holes or lateral recesses 76, for rigidly fixing the mounting bracket 16B against a mounting surface portion of a support structure using preferably flat-head screws, nails, or the like.

Also likewise the first mounting bracket 16A described above, the second mounting bracket 16B is provided with a cylindrically-shaped mounting member 92 having a C-shaped cross-section, and which has a longitudinal side portion integrally formed and disposed along a front side 84 surface portion substantially proximal and parallel to the upper edge 88 of the mounting plate member 82.

Substantially centrally disposed proximal the lower edge 90 of the mounting plate member 82 there is provided a substantially triangular-shaped support member 94 that is extending outwardly, relative to the front side surface 84, and slightly angularly toward the upper edge 88 of the plate member 82, as best illustrated in FIG. 18. The triangular support member 94 is suitably configured and shaped to support a downwardly facing, longitudinal side portion 32 or 34 of a light emitting member 12, when the latter is fixed substantially horizontally to a vertical support structure using the second mounting bracket 16B.

Thus, the second mounting bracket 16B may be used for rigidly fixing a light emitting member 12 to a mounting surface portion of a support structure such that the distal longitudinal surface 36 of the light emitting member 12 may be projecting light perpendicularly outwardly relative to the mounting surface portion.

The mounting brackets 16A and 16B are preferably made of a suitably rigid plastic material using a conventional injection molding process.

Preferably, an elongated light emitting member 12 may be fixed to a support structure by, first, rigidly fixing thereto at suitable locations a plurality of one of the two, or a suitable combination of both mounting brackets 16A and 16B, using fastening elements such as flat-head screws. Second, the mounting surface 30 of the light emitting member 12 is aligned such that the semi-circular mounting groove 40 is substantially aligned and abutting against the protruding portion of the mounting members 80 and/or 92 of the mounting brackets 16A and/or 16B respectively. Finally, as illustrated in FIGS. 1 and 3, the mounting groove 40 is engaged in a snap-fit relation onto the mounting members 80 and/or 92, by firmly pressing on the portions of the light emitting member 12 corresponding to the position of each mounting members.

Thus there is described a versatile valance light fixture 10 having a light emitting member 12 that can be easily removed for maintenance or replacement, as well as being relatively easily customizable in terms of the direction and the color of the light that it is emitting toward its surrounding space. Furthermore, a plurality of versatile valance light fixture 10 of the present invention can be easily connected in a daisy chain configuration.

Although the above description contains many specificities, these should not be construed as limitations on the scope of the invention but as merely providing one illustration of the presently preferred embodiment of this invention.

What is claimed is:

1. A versatile valance light fixture, said valance light fixture comprising:
an electrically powered light emitting member;
a first mounting bracket for mounting said light emitting member at a first angle relative to a mounting surface of a support structure;
a second mounting bracket for mounting said light emitting member at a second angle relative to a mounting surface of a support structure.

2. A versatile valance light emitting fixture as defined in claim 1, wherein said light emitting member includes:
an elongated tubular housing;
an elongated channel member adapted to be insertable in said tubular housing;
a plurality of elongated LED light strips adapted to be insertable in longitudinal grooves provided along longitudinal side portions of said channel member;
a pair of end caps for closing the distal ends of said tubular housing.
